(19) United States
(12) Patent Application Publication
(10) Pub. No.: US 2025/0357530 A1
(43) Pub. Date: Nov. 20, 2025

(54) OXIDE SOLID ELECTROLYTE COATED NI-BASED CATHODE FOR SULFIDE ALL-SOLID-STATE BATTERY

(71) Applicant: GM Global Technology Operations LLC, Detroit, MI (US)

(72) Inventors: Zhe Li, Shanghai (CN); Qili Su, Shanghai (CN); Yong Lu, Shanghai (CN); Yan Wu, Shanghai (CN); Haijing Liu, Shanghai (CN)

(21) Appl. No.: 18/670,137

(22) Filed: May 21, 2024

(30) Foreign Application Priority Data
May 14, 2024 (CN) 202410598019.4

(51) Int. Cl. H01M 10/0562; H01M 4/02; H01M 4/04; H01M 4/525; H01M 4/62

(52) U.S. Cl. CPC H01M 10/0562; H01M 4/0416; H01M 4/043; H01M 4/0471; H01M 4/525; H01M 4/623; H01M 4/625; H01M 2004/021

(57) ABSTRACT

A sulfide all-solid-state battery and a method for forming an oxide electrolyte coated cathode is provided. The battery includes a nickel-based cathode, an electrolyte coating adhered to the nickel-based cathode, an anode, and a sulfide solid electrolyte. The nickel-based cathode includes LiNi_{1-x-y-z}CoₓMn_{y}Al_{z}O₂. The electrolyte coating includes an inorganic oxide solid electrolyte including Li₁₊ₙAlₙTi₂₋ₙ(PO₄)₃ (LATP), where 1-x-y-z is greater than 0.2, x is greater than or equal to 0, y is greater than or equal to 0, and z is greater than or equal to 0, and where n is between 0.2 and 0.5. The sulfide solid electrolyte transports charged ions between the anode and the nickel-based cathode.

### CROSS-REFERENCE TO RELATED APPLICATIONS

This application claims the benefit of foreign priority under 35 U.S.C. § 119 of Chinese patent application number 202410598019.4, filed on May 14, 2024. The contents of this application are incorporated herein by reference in their entirety.

### INTRODUCTION

The present disclosure relates to a sulfide-based all-solid-state battery, and more particularly, to a coated nickel-based cathode within the sulfide-based all-solid-state battery.

Rechargeable batteries are known to be used in consumer electronic applications from small electronic devices, such as cell phones to larger electronic devices such as laptop computers. Modern rechargeable lithium-ion batteries have the ability to hold a relatively high energy density as compared to older types of rechargeable batteries such as nickel metal hydride, nickel cadmium, or lead acid batteries. A benefit of rechargeable lithium-ion batteries is that the batteries can be completely or partially charged and discharged over many cycles without retaining a charge memory. In addition, rechargeable lithium-ion batteries can be used in larger applications, such as for electric and hybrid vehicles due to the batteries' high power density, long cycle life, and ability to be formed into a wide variety of shapes and sizes so as to efficiently fill available space in such vehicles.

Modern rechargeable lithium-ion batteries typically utilize organic liquid electrolyte to carry or conduct lithium cations (Li⁺) between a cathode active material and an anode active material. To further enhance battery performance, organic liquid electrolyte is replaced by solid-state electrolyte (SSE) in more modern batteries. Solid-state electrolytes could broaden the working temperature range and improve energy density of rechargeable lithium-ion batteries. Rechargeable lithium-ion batteries having solid-state electrolytes are known to be referred to as rechargeable all-solid-state lithium ion batteries.

All-solid-state batteries (ASSB) may become a long-term, robust, and high-performance energy storage system for next-generation electric vehicles, depending on the combination and/or compatibility of electrode active materials and suitable solid electrolytes. In this regard, employing a high-specific-capacity Ni-based cathode combined with high-ionic conductivity sulfide electrolytes is promising. However, interfacial compatibility/stability between the Ni-based layered oxide and a sulfide electrolyte during repeated charge-discharge cycles is poor resulting in a deteriorated interface property and battery cell performance.

While prior art methods and systems attempt to minimize the disadvantages of employing a high-specific-capacity Ni-based cathode combined with high-ionic conductivity sulfide electrolytes and may achieve their particular purpose, a need still exists for a new and improved sulfide all-solid-state battery. Accordingly, a stable and efficient sulfide all-solid-state battery is needed.

### SUMMARY

According to several aspects of the present disclosure, a sulfide all-solid-state battery is provided. The sulfide all-solid-state battery includes a nickel-based cathode, an electrolyte coating adhered to the nickel-based cathode, an anode, and a sulfide solid electrolyte. The nickel-based cathode includes LiNi_{1-x-y-z}CoₓMn_{y}Al_{z}O₂. The electrolyte coating includes an inorganic oxide solid electrolyte including Li₁₊ₙAlₙTi₂₋ₙ(PO₄)₃ (LATP), where 1-x-y-z is greater than 0.2, x is greater than or equal to 0, y is greater than or equal to 0, and z is greater than or equal to 0, and where n is between 0.2 and 0.5. The sulfide solid electrolyte transports charged ions between the anode and the nickel-based cathode.

In accordance with another aspect of the disclosure, the nickel-based cathode of the sulfide all-solid-state battery includes an active material comprising at least one of a rock salt layered oxide, a spinel, a polyanion cathode, an olivine cathode, or a lithium transition metal oxide.

In accordance with another aspect of the disclosure, the nickel-based cathode of the sulfide all-solid-state battery includes a conductive additive comprising at least one of carbon black, graphite, graphene, graphene oxide, Super P, acetylene black, carbon nanofibers, or carbon nanotubes.

In accordance with another aspect of the disclosure, the nickel-based cathode of the sulfide all-solid-state battery includes a binder comprising at least one of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-co—hexafluoropropylene) (PVdF-HFP), polyethylene oxide (PEO), polyacrylonitrile (PAN), poly(acrylic acid) (PAA), or styrene butadiene styrene copolymer (SBS).

In accordance with another aspect of the disclosure, the nickel-based cathode of the sulfide all-solid-state battery includes a particle size (D50) of between 0.1-50 μm.

In accordance with another aspect of the disclosure, the anode of the sulfide all-solid-state battery includes an anode active material between 30-98 weight %, a solid electrolyte between 0-50 weight %, a conductive additive between 0-30 weight %, and a binder between 0-20 weight %.

In accordance with another aspect of the disclosure, the anode of the sulfide all-solid-state battery includes at least one of a carbonaceous material, silicon, silicon mixed with graphite, Li₄Ti₅O₁₂, a transition metal, a metal oxide, or a metal sulfide.

In accordance with another aspect of the disclosure, the anode of the sulfide all-solid-state battery is between 10-400 μm in thickness.

In accordance with another aspect of the disclosure, the sulfide all-solid-state battery where a coverage fraction of a surface of the nickel-based cathode by the electrolyte coating is between 20-100%.

In accordance with another aspect of the disclosure, the sulfide all-solid-state battery wherein the electrolyte coating is between 0.1-20 weight % of the nickel-based cathode.

In accordance with another aspect of the disclosure, the sulfide all-solid-state battery wherein the electrolyte coating is between 5-200 μm in thickness.

In accordance with another aspect of the disclosure, the sulfide all-solid-state battery wherein the electrolyte coating includes at least one of a garnet-type oxide electrolyte, a perovskite-type oxide electrolyte, a NASICON-type oxide, a LISICON-type oxide, a metal-doped oxide, or an aliovalent substituted oxide solid electrolyte.

In accordance with another aspect of the disclosure, the sulfide all-solid-state battery wherein the electrolyte coating includes at least one of a pseudobinary sulfide, a pseudoternary sulfide, or a pseudoquaternary sulfide.

In accordance with another aspect of the disclosure, the sulfide all-solid-state battery further comprising a filler including at least one of oxide particles, a polymer framework, polyethylene (PE), or a lithium salt.

According to several aspects of the present disclosure, a method for forming an oxide electrolyte coated cathode is provided. The method includes preparing an electrolyte coating and coating a nickel-based cathode with the electrolyte coating. The electrolyte coating includes an inorganic oxide solid electrolyte including Li₁₊ₙAlₙTi₂₋ₙ(PO₄)₃(LATP). The nickel-based cathode includes LiNi_{1-x-y-z}CoₓMn_{y}Al_{z}O₂. Additionally, 1-x-y-z is greater than 0.2, x is greater than or equal to 0, y is greater than or equal to 0, and z is greater than or equal to 0, and where n is between 0.2 and 0.5.

In accordance with another aspect of the disclosure, preparing the electrolyte coating of the method includes mixing an electrolyte starting material of LiNO₃, Al(NO₃)₃·9H₂O, Ti(OCH(CH₃)₂)₄, and H₃PO₄ with a solvent to form a precursor solution, adding a nickel-based cathode material into the precursor solution and mixing to form a coating solution, evaporating and drying the coating solution to form an electrolyte coating, and sintering the electrolyte coating at between 70° and 950° C. for between 2 and 12 hours in air.

In accordance with another aspect of the disclosure, preparing the electrolyte coating of the method includes mixing an electrolyte starting material of Li₂CO₃, Al₂NO₃, TiO₂, and NH₂H₂PO₄, wherein the electrolyte starting material is mixed according to a stoichiometric ratio of the LATP, ball milling the electrolyte starting material, sintering the electrolyte starting material to form the LATP, and grinding the LATP using a pulverizer to reduce LATP particle size. Preparing the electrolyte coating of the method also includes mechanically fusing the LATP to nickel-based cathode materials for between 10-120 minutes using a mechanical fusion machine and heating the LATP and nickel-based cathode materials for between 1-12 hours in air at between 400-800° C.

In accordance with another aspect of the disclosure, preparing the electrolyte coating includes sintering the electrolyte starting material between 700-950° C. for between 2-4 hours in air.

According to several aspects of the present disclosure, a sulfide all-solid-state battery is provided. The battery includes a nickel-based cathode, an electrolyte coating adhered to the nickel-based cathode, a lithium or lithium-based anode, and a sulfide solid electrolyte. The nickel-based cathode includes LiNi_{1-x-y-z}CoₓMn_{y}Al_{z}O₂. The electrolyte coating includes an inorganic oxide solid electrolyte including Li₁₊ₙAlₙTi₂₋ₙ(PO₄)₃, where 1-x-y-z is greater than 0.2, x is greater than or equal to 0, y is greater than or equal to 0, and z is greater than or equal to 0, and where n is between 0.2 and 0.5. The anode has a thickness of between 10 and 400 micrometers (μm). The sulfide solid electrolyte transports charged ions between the lithium or lithium-based anode and the nickel-based cathode, and the electrolyte coating has a thickness of between 5-200 μm. The sulfide solid electrolyte includes a filler, a binder, and at least one of a pseudobinary sulfide, a pseudoternary sulfide, or a pseudoquaternary sulfide.

In accordance with another aspect of the disclosure, the filler of the sulfide all-solid-state battery includes at least one of oxide particles, a polymer framework, polyethylene (PE), or a lithium salt.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of an all-solid-state-battery including a nickel-based cathode having an inorganic oxide solid electrolyte, an anode, and a sulfide solid electrolyte, in accordance with the present disclosure.

FIG. 2 is a flowchart illustrating a method for coating the nickel-based cathode with the inorganic oxide solid electrolyte as shown in FIG. 1, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

A cathode for sulfide-based all-solid-state battery is disclosed herein by coating an inorganic oxide solid electrolyte onto a nickel-based cathode material, which aims to stabilize cathode/sulfide interfaces. Nickel-based layered oxides are currently a benchmark cathode for conventional Li-ion batteries due to their high-storage capacity/energy and may be critical for use in ASSB. However, interfacial compatibility or stability with sulfide electrolytes is challenging.

Some detrimental interface behavior between a Ni-based cathode and a sulfide electrolyte includes contact loss, strong oxidation of Ni⁴⁺, and phase transition. Contact loss can be caused by structural instability of the highly delithiated cathode. Additionally, strong oxidation of Ni⁴⁺ leads to oxygen release from the lattice, and the host structure is damaged at a highly delithiated state. Moreover, phase transition occurs because of oxygen release and cation mixing during the charge-discharge cycling. This poor interfacial compatibility and stability results in a capacity degeneration with a continuously increased resistance. A current solution is to coat a LiNb₃O layer onto the cathode. However, the LiNb₃O layer exhibits poor lithium-ion conduction.

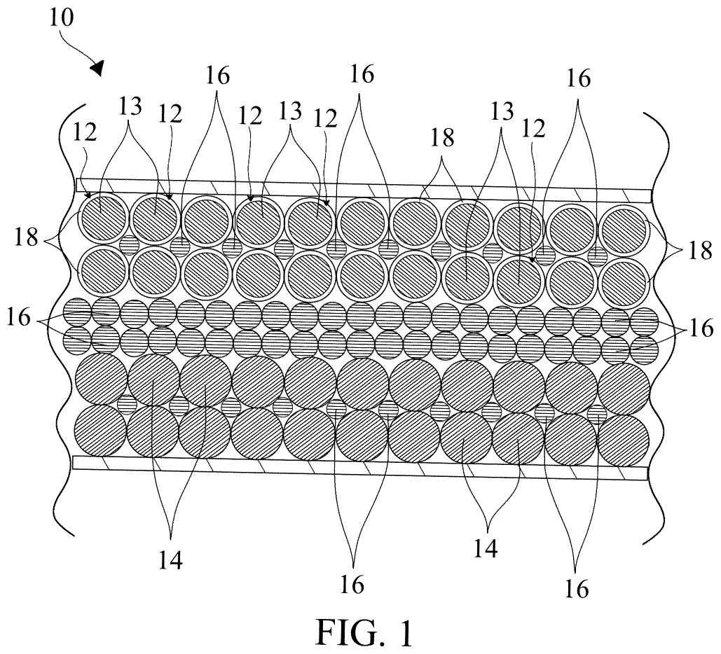

FIG. 1 illustrates a diagrammatic representation of a sulfide all-solid-state battery 10 (or “battery cell”). A plurality of the solid-state battery cells 10 may be folded or stacked to form a rechargeable all-solid-state battery and achieve a desired battery voltage, power, and energy. The sulfide all-solid-state battery 10 includes a positive electrode or a nickel-based cathode 12, a negative electrode or an anode 14, and a sulfide solid electrolyte 16.

The nickel-based cathode 12 includes a cathode active material 13 (or cathode active material particle 13), an electrolyte coating 18, a conductive additive, and/or a binder. Preferably, the nickel-based cathode 12 includes between about 30 wt. % and about 98 wt. % cathode active material 13, between about 0 wt. % and about 30 wt. % conductive additive, and between about 0 wt. % and about 20 wt. % binder.

The cathode active material 13 may comprise any suitable material such as a high-voltage oxide, a surface-coated high-voltage cathode material, a doped high-voltage cathode material, a rock salt layered oxide, a spinel, a polyanion cathode, an olivine cathode, a lithium transition metal oxide, or mixtures thereof. In one embodiment, the cathode active material 13 comprises LiNi_{1-x-y-z}CoₓMn_{y}Al_{z}O₂, LiNi_{0.5}Mn_{1.5}O₄, LiNbO₃-coated LiNi_{0.5}Mn_{1.5}O₄, LiCoO₂, LiNiₓMn_{y}Co_{1-x-y}O₂, LiNiₓMn₁₋ₓO₂, Li₁₊ₓ MO₂, LiMn₂O₄, LiV₂(PO₄)₃, or mixtures thereof, where 1-x-y-z is greater than 0.2, x is greater than or equal to 0, y is greater than or equal to 0, and z is greater than or equal to 0, and where n is between 0.2 and 0.5. In one specific example, the nickel-based cathode 12 includes a cathode active material 13 including LiNi_{0.5}Co_{0.2}Mn_{0.3}O₂ (NCM523). Additionally, the nickel-based cathode 12 may include a particle size (D50) between about 0.1 μm to about 50 μm in diameter and may be single crystals and/or secondary particles. In this context, the term “about” is known to those skilled in the art. Alternatively, the term “about” may be read to mean plus or minus 0.5% by weight. The nickel-based cathode 12 may be prepared using a wet-coating process, a dry-film process, a dry-powder coating process, and the like.

The conductive additive of the cathode layer may include any suitable material, for example carbon black, graphite, graphene, graphene oxide, Super P, acetylene black, carbon nanofibers, carbon nanotubes and other electronically conductive additives.

The binder of the cathode layer may include poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-co—hexafluoropropylene) (PVdF-HFP), polyethylene oxide (PEO), polyacrylonitrile (PAN), poly(acrylic acid) (PAA), or styrene butadiene styrene copolymer (SBS), and the like.

Referring to FIG. 1, the nickel-based cathode 12 includes an electrolyte coating 18 adhered to the nickel-based cathode active material 13 (oxide electrolyte coated cathode). The electrolyte coating 18 includes an inorganic oxide solid electrolyte, for example Li₁₊ₙAlₙTi₂₋ₙ(PO₄)₃ (LATP), where x is greater than or equal to 0, y is greater than or equal to 0, and z is greater than or equal to 0, and where n is between 0.2 and 0.5. The electrolyte coating 18 may include a garnet-type oxide electrolyte, a perovskite-type oxide electrolyte, a NASICON-type oxide, a LISICON-type oxide, a metal-doped oxide, or an aliovalent substituted oxide solid electrolyte. The electrolyte coating 18 may be between about 0.1 wt. % to about 20 wt. % of the nickel-based cathode 12. In a specific example, an electrolyte coating 18 including Li_{1.3}Al_{0.3}Ti_{1.7}(PO₄)₃ (LATP) is about 1 wt. % of the nickel-based cathode active material particle 13 such as LiNi_{0.5}Co_{0.2}Mn_{0.3}O₂ (NCM523). In this context, the term “about” is known to those skilled in the art. Alternatively, the term “about” may be read to mean plus or minus 0.5% by weight. Moreover, a coverage fraction of a surface of nickel-based cathode active material particle 13 by the electrolyte coating 18 may be between 20-100%.

Utilizing the LATP solid electrolyte coating 18 as a NASICON-type lithium-ion conductor enables a quicker lithium-ion conduction at a cathode/sulfide electrolyte interface than other commonly used coating layers. Additionally, the LATP solid electrolyte coating 18 exhibits a high electrochemical oxidative potential of about 4.2 volts (vs Li/Li⁺), which can circumvent oxidative decomposition of the electrolyte coating 18 material, inhibit interfacial interactions, and stabilize the interface between the nickel-based cathode active material particle 13 and the sulfide electrolyte coating 18. Moreover, the LATP solid electrolyte coating 18 is intrinsically stable and accordingly allows improvement of thermal stability when applied onto the surface of the nickel-based cathode 12.

As illustrated in FIG. 1, the all-solid-state battery 10 includes an anode 14. The anode 14 includes between about 30 wt. % and about 98 wt. % anode active material, between about 0 wt. % to about 50 wt. % solid electrolyte, between about 0 wt. % and about 30 wt. % conductive additive, and between about 0 wt. % and about 20 wt. % binder. The anode 14 may have a thickness of between about 10 micrometers (μm) and about 400 μm. In this context, the term “about” is known to those skilled in the art. Alternatively, the term “about” may be read to mean plus or minus 0.5% by weight. The anode active material may comprise carbonaceous material (for example, graphite, hard carbon, and soft carbon), silicon, a silicon-graphite mixture, Li₄Ti₅O₁₂, a transition-metal (e.g., Sn), a metal oxide or sulfide (e.g., TiO₂, FeS), other lithium-accepting anode materials, and the like.

The conductive additive of the anode 14 may comprise any suitable material such as carbon black, graphite, graphene, graphene oxide, Super P, acetylene black, carbon nanofibers, carbon nanotubes and other electronically conductive additives.

The binder of the anode 14 may include polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-co—hexafluoropropylene) (PVdF-HFP), polyethylene oxide (PEO), polyacrylonitrile (PAN), poly(acrylic acid) (PAA), or styrene butadiene styrene copolymer (SBS), and the like.

As illustrated in FIG. 1, the all-solid-state battery 10 includes a sulfide solid electrolyte membrane containing sulfide solid electrolyte 16. The sulfide solid electrolyte 16 transports charged ions between the anode 14 and the nickel-based cathode 12. Sulfide solid electrolytes originate from oxide solid electrolytes and are formed by replacing oxygen ions with sulfur ions. Due to lower electro-negativity, bonding strength between the sulfur and lithium ions is smaller than that of oxygen and lithium ions, which may lead to more free-moving lithium ions. Additionally, a radius of a sulfur ion is larger than that of a radius of an oxygen ion. Thus, sulfide solid electrolytes can process a larger migration tunnel for lithium ions, which is beneficial for the migration of lithium ions.

The sulfide solid electrolyte 16 may include a pseudobinary sulfide (e.g., a Li₂S—P₂S₅ system (Li₈PS₄, Li₇P₃S₁₁, and Li_{9.6}P₃S₁₂), a Li₂S—SnS₂ system (Li₄SnS₄), a Li₂S—SiS₂ system, a Li₂O—Li₂S—P₂S₅ system, a Li₂S—B₂S₃ system, a Li₂S—Ga₂S₃ system, a Li₂S—P₂S₃ system, or a Li₂S—Al₂S₃ system); a pseudoternary sulfide (e.g., a Li₂O—Li₂S—P₂S₅ system, a Li₂S—P₂S₅—P₂O₅ system, a Li₂—P₂S₅—GeS₂ system (e.g., Li_{8.25}Ge_{0.25}P_{0.75}S₄, Li₁₀GeP₂S₁₂), a Li₂S—P₂S₅—LiX (X=F, Cl, Br, I) system (e.g., LiS₆—P₆Br, Li₆PS₅Cl, Li₇P₂S₈I, Li₄PS₄I), a Li₂S—As₂S₅—SnS₂ system (e.g., Li_{8.833}Sn_{0.833}As_{0.166}S₄), a Li₂S—P₂S₅—Al₂S₃ system, a Li₂S—LiX—SiS₂ (X=F, Cl, Br, I) system (e.g., 0.4LiI·0.6Sn₂S₄, Li₁₁Si₂PS₁₂); or a pseudoquaternary sulfide (e.g., a Li₂O—Li₂S—P₂S₅—P₂O₅ system, a Li_{0.54}Si_{1.74}P_{1.44}S_{11.7}Cl_{0.3}, Li₇P_{2.9}Mn_{0.1}S_{10.7}I_{0.3}, or Li_{10.35}[Sn_{0.27}Si_{1.08}]P_{1.65}S₁₂.

The sulfide solid electrolyte membrane may include a filler. The filler may include oxide particles (e.g., SiO₂, Al₂O₃, TiO₂, or ZrO₂), a polymer framework (e.g., polypropylene (PP), polyethylene (PE), lithium salts (e.g., LiTFSI, Li₄BF, and the like), and the like.

The sulfide solid electrolyte membrane may include a binder. The binder may include poly(vinylidene fluoride) (PVDF), poly(vinylidene fluoride-co—hexafluoropropylene) (PVdF-HFP), polytetrafluoroethylene (PTFE), sodium carboxymethyl cellulose (CMC), styrene-butadiene rubber (SBR), nitrile butadiene rubber (NBR), styrene ethylene butylene styrene copolymer (SEBS), polyethylene oxide (PEO), polyvinylpyrrolidone (PVP), poly(vinyl alcohol), or poly(acrylic acid) (PAA), and the like.

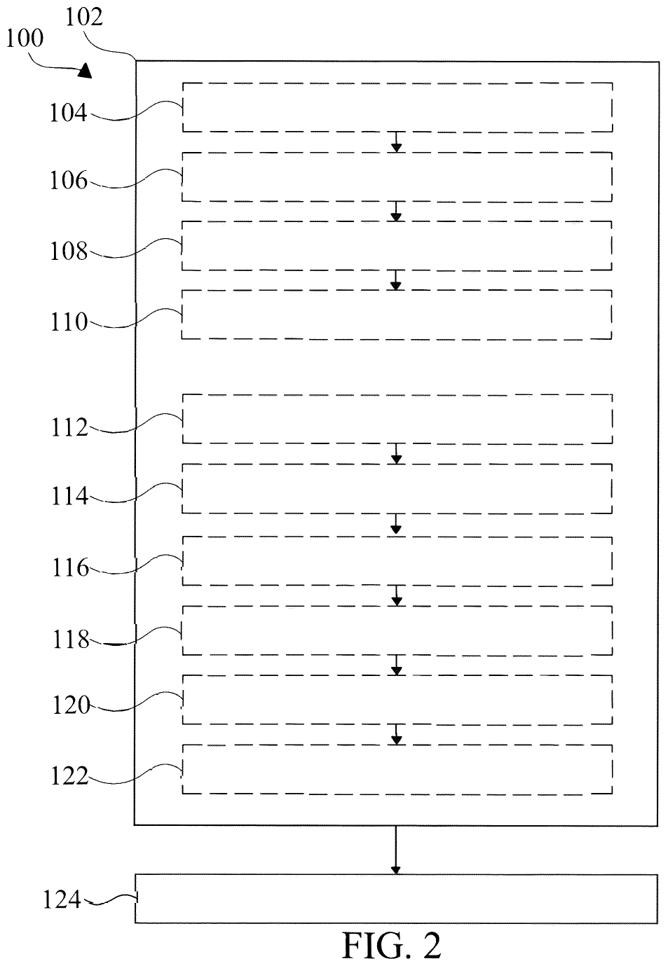

With reference to FIG. 2, a method 100 for forming an oxide electrolyte coated nickel-based cathode 12 is presented, in accordance with the present disclosure. The method starts at block 102. Block 102 depicts preparing the electrolyte coating 18. The electrolyte coating 18 includes an inorganic oxide solid electrolyte including Li₁₊ₙAlₙTi₂₋ₙ(PO₄)₃ (LATP), and wherein x is greater than or equal to 0, y is greater than or equal to 0, and z is greater than or equal to 0, and where n is between 0.2 and 0.5.

Block 104 through block 110 depicts a first example of preparing the electrolyte coating, which includes a facile sol-gel method followed by a calcination process. Block 104 depicts mixing an electrolyte starting material of LiNO₃, Al(NO₃)₃·9H₂O, Ti(OCH(CH₃)₂)₄, and H₃PO₄ with a solvent to form a precursor solution. In one example, the solvent includes anhydrous ethanol. In one example, the precursor solution includes LiNO₃ (e.g., 1.3 molar (M), Al(NO₃)₃·9H₂O (e.g., 0.3 M), Ti(OCH(CH₃)₂)₄ (e.g., 1.7 M), and H₃PO₄ (e.g., 3.0 M). The starting material(s) may be mixed using a mixer, for example a ribbon mixer. It should be appreciated that a variety of other mixers may be used to mix the electrolyte starting materials.

Block 106 depicts adding a nickel-based cathode material into the precursor solution and mixing to form a coating solution. The coating solution amount determines the coating ratio of LATP onto the nickel-based cathode 12 (e.g., (1 wt. %). The nickel-based cathode material and the precursor solution may be mixed using a mixer, for example a ribbon mixer. It should be appreciated that a variety of other mixers may be used to mix the nickel-based cathode material and the precursor solution for form the coating solution.

Block 108 depicts evaporating and drying the coating solution to form an electrolyte coating. In an example, an evaporator and/or dryer may be used for the step shown in block 108. Evaporating and drying the coating solution ensures a homogenous coating can be applied to a surface of cathode particles.

Block 110 depicts sintering the electrolyte coating. The electrolyte coating may be sintered, or calcified, at between 70° and 950° C. for between 2 and 12 hours in air, for example. A sintering furnace or other types of furnaces can be used to sinter the electrolyte coating. It should be appreciated that the electrolyte coating may be sintered at a variety of temperatures and times.

Block 112 through block 122 depicts a second example of preparing the electrolyte coating, which includes a facile mechanical fusion method. Block 112 depicts mixing an electrolyte starting material of Li₂CO₃, Al₂NO₃, TiO₂, and NH₂H₂PO₄ (LATP), wherein the electrolyte starting material is mixed according to a stoichiometric ratio of the LATP. The electrolyte starting materials may be mixed in a dry mixer or another mixer capable of mixing dry materials.

Block 114 depicts ball milling the electrolyte starting material. The electrolyte starting materials may be milled using a ball mixer or another mixer capable of mixing the electrolyte starting materials.

Block 116 depicts sintering the electrolyte starting material to form the LATP. The electrolyte coating may be sintered, or calcified, at between 70° and 950° C. (e.g., 900° C.) for between 2 and 12 hours (e.g., 4 hours) in air, for example. A sintering furnace or other types of furnaces can be used to sinter the electrolyte coating. It should be appreciated that the electrolyte coating may be sintered at a variety of temperatures and times. In some instances, a pre-prepared powder including an LATP starting material may be used and the steps of blocks 112 through 116 may be skipped. In these instances and this example of preparing the electrolyte coating, block 102 would begin instead at block 118.

Block 118 depicts grinding the LATP using a pulverizer to reduce LATP particle size. Grinding the LATP with the pulverizer may include reducing a particle size of the LATP powder to hundreds of nanometers, for example particles with an average of about 400 nanometers (nm).

Block 120 depicts mechanically fusing the LATP to the nickel-based cathode materials for between 10-120 minutes using a mechanical fusion machine.

Block 122 depicts heating the LATP and nickel-based cathode materials for between 1-12 hours in air at between 400-800° C. The resulting heated LATP and nickel-based cathode materials form a final material for coating the nickel-based cathode 12. Either block 110 or block 122 then proceeds to block 124.

Block 124 depicts coating a nickel-based cathode active material particle 13 with the electrolyte coating 18, wherein the nickel-based cathode active material particle 13 includes LiNi_{1-x-y-z}CoₓMn_{y}Al_{z}O₂. The nickel-based cathode active material with the electrolyte coating 18 may be used to prepare nickel-based cathode layer 12 by a wet-coating process, a dry-film process, a dry powder-coating process, and the like. The resulting nickel-based cathode 12 includes between about 30 wt. % and about 98 wt. % cathode active material particle 13, between about 0 wt. % and about 30 wt. % conductive additive, and between about 0 wt. % and about 20 wt. % binder.

The all-solid-state battery 10 and nickel-based cathode 12 of the present disclosure is advantageous and beneficial over prior art solid-state lithium batteries or other lithium batteries. The electrolyte coating 18 enables a quicker lithium-ion conduction at a cathode/sulfide electrolyte interface than other commonly used coating layers. Additionally, the LATP solid electrolyte coating 18 exhibits a high electrochemical oxidative potential, which can circumvent oxidative decomposition of the electrolyte coating 18 material, inhibit interfacial interactions, and stabilize the interface between the nickel-based cathode 12 and the sulfide electrolyte coating 18. The LATP solid electrolyte coating 18 is intrinsically stable and accordingly allows improvement of thermal stability.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A sulfide all-solid-state battery, comprising:
a nickel-based cathode, wherein the nickel-based cathode includes LiNi_{1-x-y-z}CoₓMn_{y}Al_{z}O₂;
an electrolyte coating adhered to the nickel-based cathode, wherein the electrolyte coating includes an inorganic oxide solid electrolyte including Li₁₊ₙAlₙTi₂₋ₙ(PO₄)₃ (LATP), and wherein 1-x-y-z is greater than 0.2, x is greater than or equal to 0, y is greater than or equal to 0, and z is greater than or equal to 0, and where n is between 0.2 and 0.5;
an anode; and
a sulfide solid electrolyte, wherein the sulfide solid electrolyte transports charged ions between the anode and the nickel-based cathode.

2. The sulfide all-solid-state battery of claim 1, wherein the nickel-based cathode includes an active material comprising at least one of a rock salt layered oxide, a spinel, a polyanion cathode, an olivine cathode, or a lithium transition metal oxide.

3. The sulfide all-solid-state battery of claim 1, wherein the nickel-based cathode includes a conductive additive comprising at least one of carbon black, graphite, graphene, graphene oxide, Super P, acetylene black, carbon nanofibers, or carbon nanotubes.

4. The sulfide all-solid-state battery of claim 1, wherein the nickel-based cathode includes a binder comprising at least one of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-co—hexafluoropropylene) (PVdF-HFP), polyethylene oxide (PEO), polyacrylonitrile (PAN), poly(acrylic acid) (PAA), or styrene butadiene styrene copolymer (SBS).

5. The sulfide all-solid-state battery of claim 1, wherein the nickel-based cathode includes a particle size (D50) of between 0.1-50 μm.

6. The sulfide all-solid-state battery of claim 1, wherein the anode includes an anode active material between 30-98 weight %, a solid electrolyte between 0-50 weight %, a conductive additive between 0-30 weight %, and a binder between 0-20 weight %.

7. The sulfide all-solid-state battery of claim 1, wherein the anode includes at least one of a carbonaceous material, silicon, silicon mixed with graphite, Li₄Ti₅O₁₂, a transition metal, a metal oxide, or a metal sulfide.

8. The sulfide all-solid-state battery of claim 1, wherein the anode is between 10-400 μm in thickness.

9. The sulfide all-solid-state battery of claim 1, wherein a coverage fraction of a surface of the nickel-based cathode by the electrolyte coating is between 20-100%.

10. The sulfide all-solid-state battery of claim 1, wherein the electrolyte coating is between 0.1-20 weight % of the nickel-based cathode.

11. The sulfide all-solid-state battery of claim 1, wherein the electrolyte coating is between 5-200 μm in thickness.

12. The sulfide all-solid-state battery of claim 1, wherein the electrolyte coating includes at least one of a garnet-type oxide electrolyte, a perovskite-type oxide electrolyte, a NASICON-type oxide, a LISICON-type oxide, a metal-doped oxide, or an aliovalent substituted oxide solid electrolyte.

13. The sulfide all-solid-state battery of claim 1, wherein the electrolyte coating includes at least one of a pseudobinary sulfide, a pseudoternary sulfide, or a pseudoquaternary sulfide.

14. The sulfide all-solid-state battery of claim 1, further comprising a filler including at least one of oxide particles, a polymer framework, polyethylene (PE), or a lithium salt.

15. A method for forming an oxide electrolyte coated cathode, comprising:
preparing an electrolyte coating, wherein the electrolyte coating includes an inorganic oxide solid electrolyte including Li₁₊ₙAlₙTi₂₋ₙ(PO₄)₃ (LATP); and
coating a nickel-based cathode with the electrolyte coating, wherein the nickel-based cathode includes LiNi_{1-x-y-z}CoₓMn_{y}Al_{z}O₂,
wherein 1-x-y-z is greater than 0.2, x is greater than or equal to 0, y is greater than or equal to 0, and z is greater than or equal to 0, and where n is between 0.2 and 0.5.

16. The method of claim 15, wherein preparing the electrolyte coating includes:
mixing an electrolyte starting material of LiNO₃, Al(NO₃)₃·9H₂O, Ti(OCH(CH₃)₂)₄, and H₃PO₄ with a solvent to form a precursor solution;
adding a nickel-based cathode material into the precursor solution and mixing to form a coating solution;
evaporating and drying the coating solution to form an electrolyte coating; and
sintering the electrolyte coating at between 70° and 950° C. for between 2 and 12 hours in air.

17. The method of claim 15, wherein preparing the electrolyte coating includes:
mixing an electrolyte starting material of Li₂CO₃, Al₂NO₃, TiO₂, and NH₂H₂PO₄, wherein the electrolyte starting material is mixed according to a stoichiometric ratio of the LATP;
ball milling the electrolyte starting material;
sintering the electrolyte starting material to form the LATP;
grinding the LATP using a pulverizer to reduce LATP particle size;
mechanically fusing the LATP to nickel-based cathode materials for between 10-120 minutes using a mechanical fusion machine; and
heating the LATP and nickel-based cathode materials for between 1-12 hours in air at between 400-800° C.

18. The method of claim 15, wherein sintering the electrolyte starting material between 700-950° C. for between 2-4 hours in air.

19. A sulfide all-solid-state battery, comprising:
a nickel-based cathode, wherein the nickel-based cathode includes LiNi_{1-x-y-z}CoₓMn_{y}Al_{z}O₂;
an electrolyte coating adhered to the nickel-based cathode, wherein the electrolyte coating includes an inorganic oxide solid electrolyte including Li₁₊ₙAlₙTi₂₋ₙ(PO₄)₃, and wherein 1-x-y-z is greater than 0.2, x is greater than or equal to 0, y is greater than or equal to 0, and z is greater than or equal to 0, and where n is between 0.2 and 0.5;
a lithium or lithium-based anode, wherein the anode has a thickness of between 10 and 400 micrometers (μm); and
a sulfide solid electrolyte, wherein the sulfide solid electrolyte transports charged ions between the lithium or lithium-based anode and the nickel-based cathode, and wherein the electrolyte coating has a thickness of between 5-200 μm, and wherein the sulfide solid electrolyte includes:
at least one of a pseudobinary sulfide, a pseudoternary sulfide, or a pseudoquaternary sulfide;
a filler; and
a binder.

20. The sulfide all-solid-state battery of claim 19, wherein the filler includes at least one of oxide particles, a polymer framework, polyethylene (PE), or a lithium salt.
